(19) United States
(12) Patent Application Publication
(10) Pub. No.: US 2014/0360625 A1
(43) Pub. Date: Dec. 11, 2014

(54) OVERFILL CONTAINMENT SYSTEMS FOR TANKERS

(71) Applicant: Marlon WILLIAMSON, Arnegard, ND (US)

(72) Inventor: Marlon WILLIAMSON, Arnegard, ND (US)

(21) Appl. No.: 14/085,184

(22) Filed: Nov. 20, 2013

Related U.S. Application Data
(60) Provisional application No. 61/833,333, filed on Jun. 10, 2013.

(51) Int. Cl. B67D 7/36; B67D 7/78

(52) U.S. Cl. CPC B67D 7/362; B67D 7/78
USPC 141/94; 141/121

(57) ABSTRACT

An overfill containment system for a tanker has an overflow tank having an inlet selectively fluidly coupleable to a vapor-release system of the tanker and an outlet selectively fluidly coupleable to an input/output port of the tanker and to an inlet/outlet of a tank of the tanker. The input/output port of the tanker and the inlet/outlet of the tank are for liquid, e.g., hazardous, volatile, and/or flammable liquid, gasoline, oil, fuel, fuel oil, chemicals, etc.

### RELATED APPLICATION

This application claims priority to U.S. Provisional Application No. 61/833,333, filed on Jun. 10, 2013, titled “CARGO TANKER OVER FILL CONTAINMENT SYSTEM,” which is incorporated herein by reference in its entirety.

### FIELD

The present disclosure relates generally to tankers, and, in particular, the present disclosure relates to overfill containment systems for tankers.

### BACKGROUND

With the rise in oil production and the need for carrying this precious commodity, wasting it becomes an unacceptable practice for the oil production companies. The Environmental Protection Agency (EPA) has regulations on preventing oil spills, and oil shipping companies have to obey and act in the best interest of these regulations. In recent years, reports have shown that an estimate of 18,000-24,000 oil spills occur from the production, storage, transport, and use of oil, and about 10-25 million gallons of oil are spilled yearly. These oil spills not only affect the companies in terms of monetary loss, but they also can release toxins into our environment, threatening public health and safety and damaging wildlife habitats. With the increased oil production in the U.S. in particular, transporting this commodity becomes crucial in order to refine the extracted oil substances into various by-products. The methods of transporting oil can vary from air, sea, and land but the most efficient and cost effective method is through sea transportation. Unfortunately, there are many situations which require oil, or other liquids, such as hazardous, volatile, and/or flammable liquids, gasoline, fuels, fuel oil, chemicals, etc., to be transported over land, and this requires trucks equipped with large tanks to be utilized. These trucks, also known simply as tankers, require that specific measures of safety and precision be taken in order to deliver the oil to its destination whether it's a local gas station, refinery, or factory fuel supply.

Some tankers (e.g., sometimes called cargo tankers) might carry up to about 11000 gallons, for example, but this may vary based on the type and size of the tankers. The EPA has certain requirements that must be obeyed by tankers, for example collection efficiency should be assumed to be 98.7 percent. This means that for tanker trucks without leakage, the tanker should not be filled to 100 percent of its capacity.

After the BP oil spill catastrophe, the EPA has added some new requirements concerning over filling tankers, such as the use of specially designed overflow prevention systems that are installed in accordance with industry standards and safety codes. In turn, these requirements and regulations cause oil transporters to look into safety measures and equipment that can prevent oil spillage from their fleet. Some of the tankers currently utilized lack any sort of overflow prevention equipment, and typically gauges might be the only equipment that is available for monitoring the tanker's capacity. These gauges are either mechanical or electrical based and can be seen on the side of the oil tankers. Sometimes tankers may be are equipped with an alarm system for indicating an undesirable liquid level in a tanker. Unfortunately, the existing alarm systems often fail even though they are set to function at near capacity level.

For the reasons stated above, and for other reasons stated below which will become apparent to those skilled in the art upon reading and understanding the present specification, there is a need in the art for alternatives to existing overfill systems.

### BRIEF DESCRIPTION OF THE DRAWINGS

FIG. 1 is the isometric view of a tanker that includes an example of an overfill containment system.

FIG. 2 is the left view of the tanker in FIG. 1.

FIG. 3 is the right view of the tanker in FIG. 1.

FIG. 4 is the front view of the tanker in FIG. 1.

FIG. 5 is the rear view of the tanker in FIG. 1.

FIG. 6 is the bottom view of the tanker in FIG. 1.

FIG. 7 is the top view of the tanker in FIG. 1.

FIG. 8 is a block diagram illustrating an example of an overfill containment system interfacing with components of a tanker.

### DETAILED DESCRIPTION

In the following detailed description, reference is made to the accompanying drawings that form a part hereof, and in which is shown, by way of illustration, specific embodiments. In the drawings, like numerals describe substantially similar components throughout the several views. Other embodiments may be utilized and structural, mechanical, and electrical changes may be made without departing from the scope of the present disclosure. The following detailed description is, therefore, not to be taken in a limiting sense.

An overfill containment system in the examples disclosed herein includes an overflow tank that collects liquid, such as hazardous, volatile, and/or flammable liquid, gasoline, oil, fuel, fuel oil, chemicals, etc., that overflows from a tank of a tanker, e.g., through the tanker's vapor-release system. This advantageously prevents the overflowing liquid from spilling onto the ground. In some examples, the overfill containment system allows the collected liquid to be emptied from the overflow tank. For example, the overfill containment system may allow the collected liquid to flow from the overflow tank to an inlet/outlet port of the tanker for liquids, e.g., that can be coupled to a bulk tank that is external to the tanker. In another example, the containment system may allow the collected liquid to flow from the overflow tank to an inlet/outlet of the tank of the tanker so that the liquid can be returned to the tank of the tanker from the overflow tank. In some examples, the overfill containment system may be configured to sense the overflowing liquid and to trigger an alarm in response to sensing the overflowing liquid.

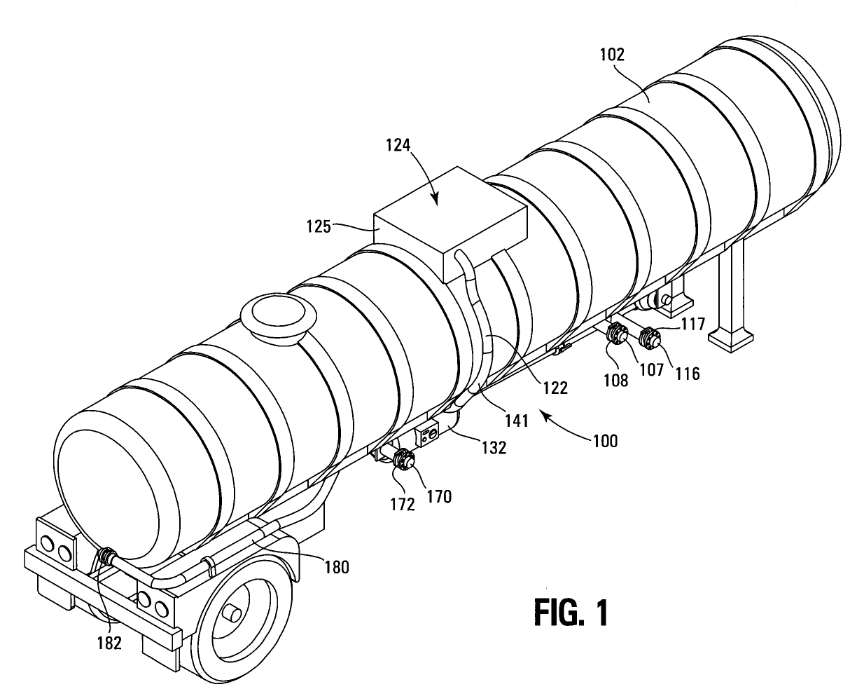

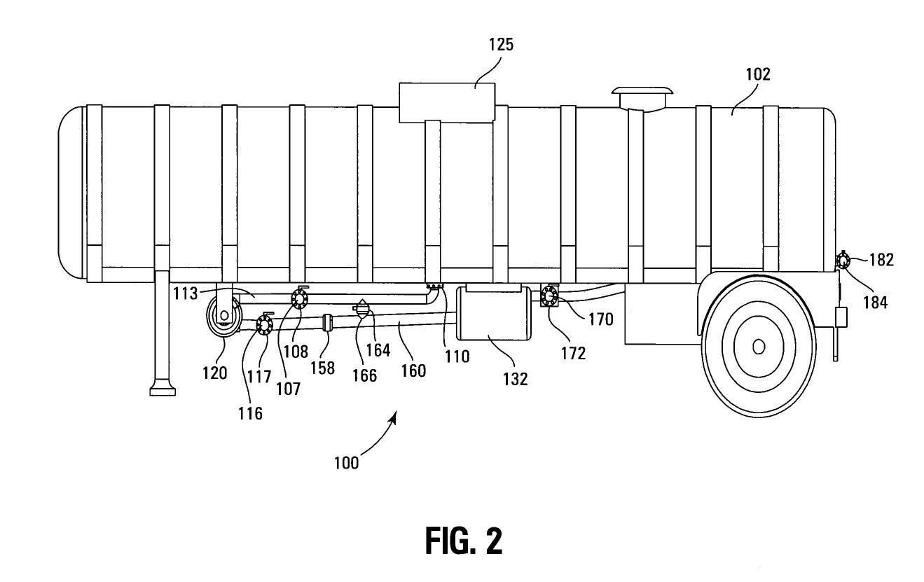

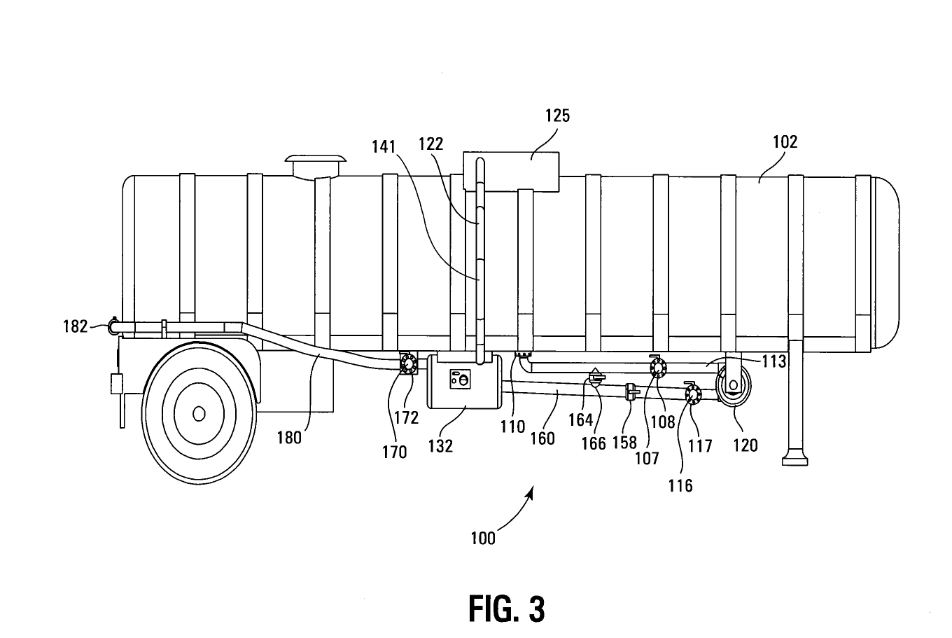

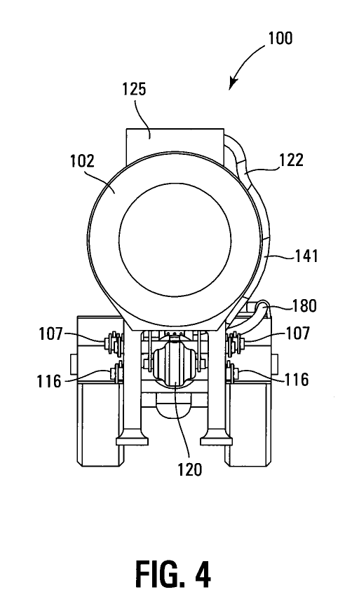

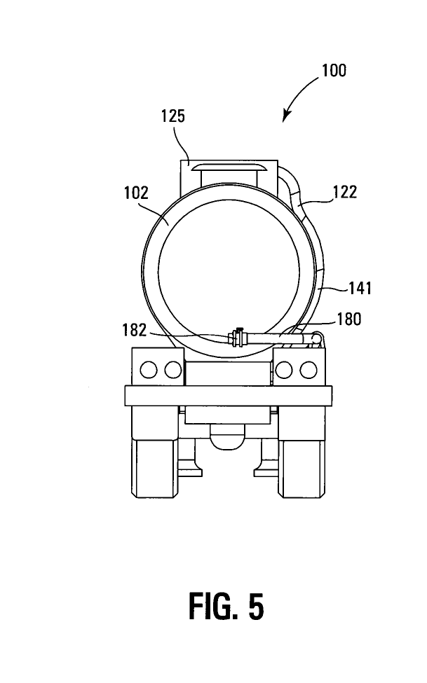

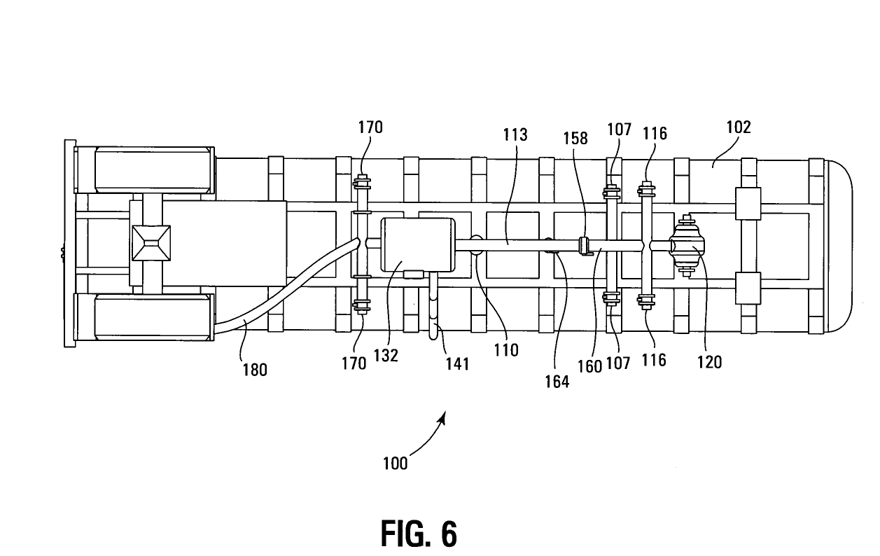

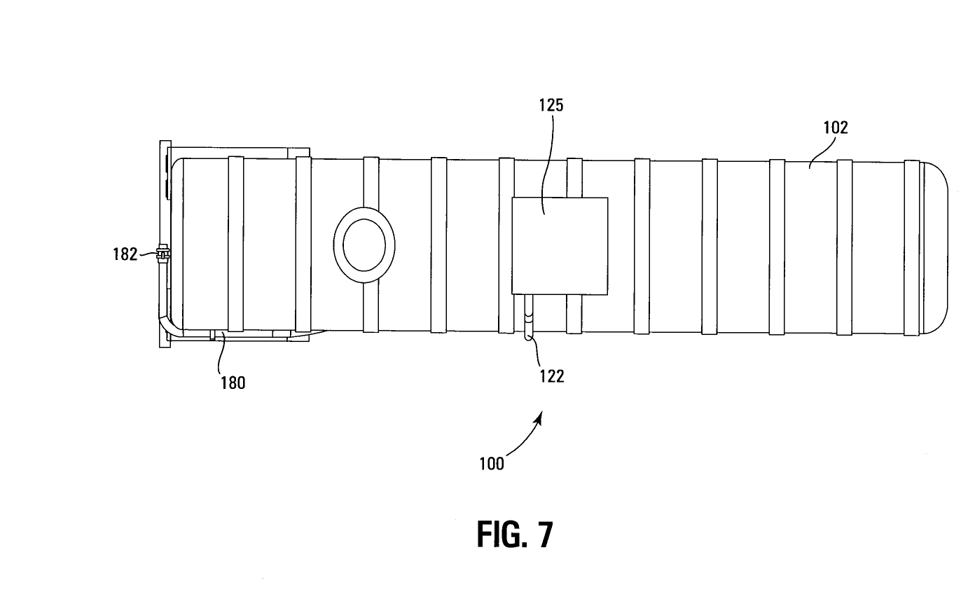

FIGS. 1-7 illustrate a tanker 100, such as a tanker (e.g., that might be referred to as a cargo tanker) for containing and transporting (e.g., over land) liquid, such as hazardous, volatile, and/or flammable liquid, gasoline, oil, fuel, fuel oil, chemicals, etc. Tanker 100 might be a land-based tanker and might be carried over the road on a trailer as part of a tractor-trailer combination. Alternatively, tanker 100 might be self-propelled.

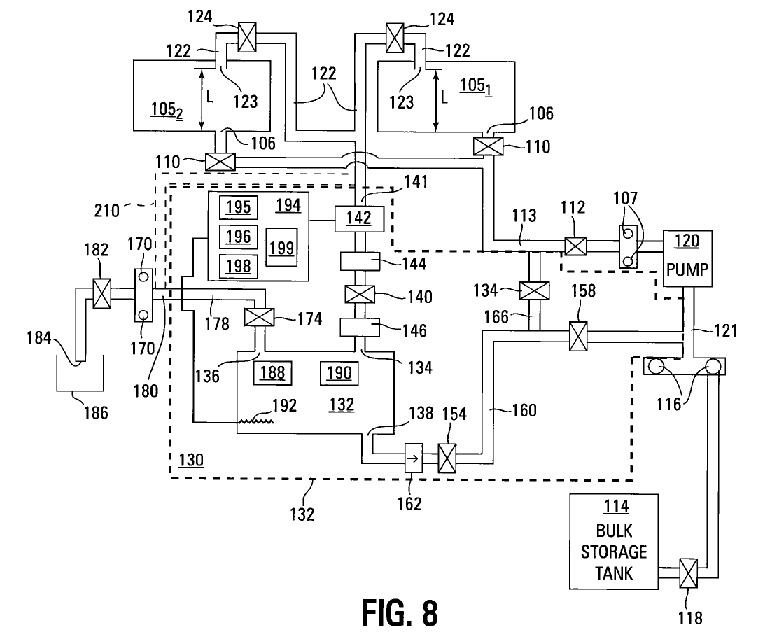

Tanker 100 includes a tank 102 and a fluid-handling system that may include a liquid-handling system configured to direct liquids to and from tank 102 and a vapor-release system (e.g., sometimes called a vapor-recovery system) for venting gasses, such as air and the vapors that evaporate from the liquids, from tank 102, as tank 102 is being filled with liquid. Tank 102 might contain one or more compartments, such as compartments 105₁ and 105₂, as shown in FIG. 8. Note that for a single-compartment tank, one of compartments 105₁ and 105₂ would be the tank. Although two compartments 105 are shown, tanker 100 can include more than two compartments.

Note that common reference numbers denote similar (e.g., the same) components throughout FIGS. 1-8. For example, the reference numbers that denote components discussed in conjunction with FIG. 8 also denote similar (e.g., the same) components in FIG. 1-7.

As shown in FIG. 8, compartments 105₁ and 105₂ include inlet/outlets 106 e.g., that may pass through the bottoms of compartments 105₁ and 105₂, where inlet/outlets 106 are for receiving liquids and for expelling liquids. Compartments 105₁ and 105₂, e.g., inlet/outlets 106 of compartments 105₁ and 105₂, might be selectively fluidly coupled to one or more inlet/outlet ports 107 (e.g., for liquid) of tanker 100 through air-actuated valves 110 (e.g., sometimes called fire valves) of the liquid-handling system of tanker 100 and through a valve, such as manually activated valve 112 (e.g., a ball valve), of the liquid-handling system of tanker 100.

A flow line 113 (e.g., a pipe) of the liquid-handling system of tanker 100 extends from a pump 120 to air-actuated valves 110. Inlet/outlet ports 107 are selectively fluidly coupled to the flow passage in flow line 113, and valve 112 is located in flow line 113. Valves (FIG. 1), such as manually operated valves 108 (e.g., ball valves), might be used to selectively open and close inlet/outlet ports 107. Valves 108 selectively fluidly couple inlet/outlet ports 107 to the flow line 113.

As used herein “fluidly coupled” means to allow the flow of fluid (e.g., gasses, including air and/or vapor from a liquid, or liquid). For example, fluid is allowed to flow between fluidly coupled elements, i.e., from one of the fluidly coupled elements to the other. For selectively fluidly coupled elements, fluid flows from one of the elements to the other in response to an action, such as the opening of a valve between the elements. That is, when one or more valves are between two elements, the two elements are selectively fluidly coupled to each other, for example. When flow lines are fluidly coupled, the flow passages within these flow lines are fluidly coupled, for example.

Inlet/outlet ports 107 might be fluidly coupleable to a bulk-storage tank 114 of a bulk-storage system through a pump (not shown) of the bulk-storage system. Note that air-actuated valves 110 may be respectively physically connected to the bottoms of compartments 105₁ and 105₂ and fluidly coupled to inlet/outlets 106, as shown in FIG. 8. The bulk storage system 114 may be configured to output liquid to tanker 100 through an inlet/outlet port 107 for transport or to receive transported liquid from tanker 100 through an inlet/outlet port 107.

Compartments 105₁ and 105₂, and thus the inlet/outlets 106 thereof, might also be selectively fluidly coupled to one or more inlet/outlet ports 116 (e.g., for liquid) through air-actuated valves 110, through valve 112, and a pump 120, such as a bi-directional pump, of the liquid-handling system of tanker 100. Valves (FIG. 1), such as manually operated valves 117 (e.g., ball valves), might be used to selectively open and close inlet/outlet ports 116. Valves 117 selectively fluidly couple inlet/outlet ports 116 to pump 120. A valve, such as manually activated valve 118 (e.g., a ball valve), might be used to selectively fluidly couple bulk storage tank 114 to inlet/outlet ports 107 and inlet/outlet ports 116.

Pump 120 might be fluidly coupled to a flow line 121 (e.g., a pipe) of the liquid-handling system of tanker 100. Inlet/outlet ports 116 are selectively fluidly coupled to flow line 121 and thus pump 120, e.g., by valves 117. Pump 120, when operating in a first direction, draws liquid from bulk-storage tank 114 through an inlet/outlet port 116. When operating in a second direction opposite to the first direction, pump 120 draws liquid from tanker 100 and outputs the liquid through an inlet/outlet port 116.

A vapor recovery (e.g., a vapor release) flow line 122 (e.g., a pipe) of the vapor-release system of the fluid-handling system of tanker 100 extends into each of compartments 105₁ and 105₂ through the top of each of compartments 105₁ and 105₂, as shown in FIG. 8. Inlets 123 to the vapor recovery flow line 122, and thus the vapor-release system, open into the interior of each of compartments 105₁ and 105₂. An air-activated valve 124, e.g., a vapor release valve, of the vapor-release system of tanker 100 might be located in each vapor-recovery line 122. An air-activated valve 124 is activated while a respective compartment 105 is being filled with liquid from the bottom, so that vapor in the respective compartment 105 is forced through the respective vapor-recovery line 122 and the respective air-activated valve 124. Air-activated valve 124 is sometimes located in an open-topped box 125 at the top of tank 102 of tanker 100.

Vapor recovery flow line 122 might extend into compartments 105₁ and 105₂ so that the end of and the inlet 123 to vapor recovery flow line 122 are at a level L from the bottom of compartments 105₁ and 105₂ (FIG. 8), corresponding to compartments 105₁ and 105₂ being 98.7 percent full, an EPA limit. For example, liquid will enter vapor recovery flow line 122 through inlet 123 when the liquid level reaches the level L, e.g., and compartments 105₁ and 105₂ are 98.7 percent full.

The tanker 100 illustrated in FIGS. 1-7 includes an example of an overfill containment system, such as an overfill containment system 130, shown FIG. 8, that is coupled to the fluid-handling system of tanker 100. Overfill containment system 130 may be added, e.g., as an after-market add-on (e.g., as a retrofit), to tankers already in use or may be added to tankers during their manufacture, for example. In other examples, the overfill containment system 130 might be included as an external attachment on tanker 100 to provide overflow protection. Overfill containment system 130 is mounted on tanker 100 so that overfill containment system 130 travels with tanker 100 as tanker 100 travels over land. Note that the region enclosed by the dashed line 132 in FIG. 8 includes the overfill containment system 130.

The overfill containment system 130 includes an overflow (e.g., a containment) tank 132. The overflow tank 132 receives excess liquid, such as hazardous, volatile, and/or flammable liquids, gasoline, oil, fuel, fuel oil, chemicals, etc., overflowing from compartments 105 and prevents it from spilling out of tanker 100. As shown in FIG. 1, the overflow tank 132 might be placed on the bottom of tanker 100. Overflow tank 132 is mounted on tanker 100 so that overflow tank 132 travels with tanker 100 as tanker 100 travels over land. For example, overflow tank 132 can be secured to tanker 100 either with the use of extended supporting arms or welded to the body of tanker 100.

Overflow tank 132 might include an inlet 134 (e.g., passing through the top of overflow tank 132), an outlet 136 (e.g., passing through the top of overflow tank 132), and an outlet 138 (e.g., passing through the bottom of overflow tank 132), as shown in FIG. 8. The interior of overflow tank 132, and thus inlet 134, is selectively fluidly coupled to the interiors of compartments 105₁ and 105₂. For example, air-activated valves 124 of the vapor-release system of tanker 100 and a valve, such as a manually operated valve 140 (e.g., a ball valve), of overflow system 130 might selectively fluidly couple the interior of overflow tank 132, and thus outlet 134, to the interiors of compartments 105₁ and 105₂. Note that valve 140 selectively fluidly couples outlet 134 to vapor-recovery lines 122, and thus to the vapor-release system of tanker 100, for example.

A flow line 141 (e.g., a pipe) of overflow system 130 might be between and physically coupled to overflow tank 132 and vapor-recovery lines 122, where the flow passages in vapor-recovery lines 122 are fluidly coupled to the flow passage in line 141 and where the interior of overflow tank 132 is fluidly coupled to the flow passage in line 141 through inlet 134. The valve 140 is located in line 141. Note that inlet 134 is selectively fluidly coupled to compartments 105 by valve 140 and valves 124.

A flow sensor 142 might be located in flow line 141 and may be fluidly coupled in series with an air-activated valve 124 and valve 140, e.g., flow sensor 142 may be between an air-activated valve 124 and valve 140, as shown in FIG. 8. Flow sensor 142 might be configured to output an electrical signal in response to sensing a flow of liquid (e.g., a continuous flow of liquid) therethrough. An example of a suitable flow sensor is the Sick model Model CM30-1BPP-KCL flow sensor, part number 6020475, manufactured by Sick AG (Waldkirch, Germany). Note that flow sensor 142 is selectively fluidly coupled to outlet 134 by valve 140 and is fluidly coupled to valves 124 so that flow sensor 142 is selectively fluidly coupled to compartments 105 by valves 124.

A filter 144 might be located in flow line 141 and may be fluidly coupled in series with an air-activated valve 124, flow sensor 142, and valve 140, e.g., flow sensor 142 may be between an air-activated valve 124 and valve 140, as shown in FIG. 8. For example, filter 144 may be fluidly coupled in series with flow sensor 142 between flow sensor 142 and valve 140. Note that filter 144 is selectively fluidly coupled to outlet 134 by valve 140 and is fluidly coupled to valves 124 so that filter 144 is selectively fluidly coupled to compartments 105 by valves 124.

Filter 144 may be configured to separate solids from liquid and gasses. For example, filter 144 may include a mesh, e.g., a stainless-steel mesh, that collects solids that may be contained in the flowing gasses and liquid and subsequently allows the solids to pass therethrough into overflow tank 132. Filter 144 may also separate the liquid from the gasses, owing to the higher viscosity of the liquid.

A sight glass 146 might be located in flow line 141 and may be fluidly coupled in series with an air-activated valve 124, flow sensor 142, filter 144, and valve 140, e.g., flow sensor 142 may be between overflow tank 132 and valve 140, as shown in FIG. 8. Sight glass 146 allows liquid flowing through flow line 141 to be observed. Note that sight glass 146 is selectively fluidly coupled to valves 124 by valve 140 so that sight glass 146 is selectively fluidly coupled to compartments 105 by valves 124 and valve 140.

The interior of overflow tank 132 and outlet 138 are selectively fluidly coupled to inlet/outlet ports 116. For example, valves, such as manually operated valves 154 and 158 (e.g., ball valves) might selectively couple interior of overflow tank 132 and outlet 138 to inlet/outlet ports 116. Moreover, the interior of overflow tank 132 and outlet 138 are selectively fluidly coupled to pump 120 by valves 154 and 158. Note that outlet 138 might pass through the bottom of overflow tank 132.

A flow line 160 (e.g., a pipe) of overflow system 130 might be between and physically coupled to overflow tank 132 and a flow line 121 of the liquid-handling system of tanker 100 that is between pump 120 and inlet/outlet ports 116. The valves 154 and 158 are located in flow line 160. A check valve 162 is also located in flow line 160 and restricts the flow through flow line 160 to an outflow from overflow tank 132 only. As such, flow line 160 and outlet 138 may be configured for outflow only, thus preventing flow from entering overflow tank 132 through outlet 138. For example, outlet 138 is fluidly coupled to check valve 162. Flow line 160 might be fluidly coupled to the flow line 121 of the liquid-handling system of tanker 100.

A valve, such as manually operated valve 164 (e.g., a ball valve), e.g., that might be referred to a vertical valve, is fluidly and physically coupled between flow line 113 and flow line 160. Manually operated valve 164 selectively fluidly couples overflow system 130 to the fluid-handling system of tanker 100. For example, valve 164 might be in a flow line 166 (e.g., a pipe) fluidly coupled between flow line 113 and flow line 160.

Note that outlet 138 is selectively fluidly coupled to inlet/outlet ports 107 by valves 154, 164 and 112 and to inlet/outlet ports 116, flow line 121, and pump 120 by valves 154 and 158. Also note that outlet 138 is selectively fluidly coupled to line 113 by valves 154 and 164 and that outlet 138 is selectively fluidly coupled to inlet/outlets 106 by valves 154, 164, and 110.

The interior of overflow tank 132 and outlet port 136 are selectively fluidly coupled to outlet ports 170, such as vents, (e.g. vapor recovery ports) of the vapor-release system of tanker 100. Valves (FIG. 1), such as manually operated valves 172 (e.g., ball valves), of the vapor-release system of tanker 100 might be used to selectively open and close outlet ports 170 for selectively coupling outlet ports 170 to atmosphere, e.g., surrounding tanker 100. A valve, such as a manually activated valve 174 (e.g., a ball valve) and valves 172 selectively fluidly couple interior of overflow tank 132 and outlet port 136 to outlet ports 170.

Valve 174 is in a vapor recovery flow line 178 (e.g., of overfill containment system 130) that is fluidly coupled between outlet 136 and a vapor recovery (e.g., a vapor release) flow line 180, such as vent line (e.g., that may be three inches in diameter), of the vapor-release system of tanker 100 that is selectively fluidly coupled to outlet ports 170 by valves 172. A valve, such as manually activated valve 182 (e.g., a ball valve), of the vapor-release system of tanker 100 might be located in vapor recovery flow line 180 for selectively fluidly coupling to atmosphere through a valve, such as manually activated valve 182 (e.g., a ball valve). For example, valve 182 might open and close an outlet port 184 of flow line 180 to selectively couple outlet port outlet port 184 to flow line 180. As such, interior of overflow tank 132 and outlet 136 are selectively fluidly coupled to outlet ports 170 and 184 of the vapor-release system, and thus to atmosphere, by valves 174, 172, and 180. Note that outlet port 136 is selectively fluidly coupled to vapor recovery flow line 180 by valve 174. Also note that ports 170 and 184 open to the atmosphere surrounding tanker 100.

Some tankers might have an open-topped bucket 186 positioned under outlet port 184. Bucket 186 may be used for capturing liquid overflow from tank 102 (e.g., from compartment 105₁ and/or compartment 105₂). A bucket 186 may also be positioned under each of outlet ports 170.

Overfill containment system 130 may include a measuring system that might include a liquid-level gauge 188, a pressure gauge 190, a liquid sensor 192, and flow sensor 142. Liquid-level gauge 188 might be coupled to the interior of overflow tank 132 for indicating the liquid level in overflow tank 132. For example, liquid-level gauge 188 might include a float that is fluidly coupled to the interior of overflow tank 132. An example of a suitable liquid-level gauge is the Rochester 6403-11 available from Rochester Gauges, Inc. (Dallas, Tex., U.S.A.).

Pressure gauge 190 (e.g., that can measure vacuum of positive gauge pressure) might be fluidly coupled to the interior overflow tank 132. Liquid sensor 192 might be located within the interior of overflow tank 132. Liquid sensor 192 may be configured to output an electrical signal in response to sensing the presence of liquid in overflow tank 132. An example of a suitable liquid level sensor is the Sick model LFV200-xxxSNATPM level sensor, part number 6036354, manufactured by Sick AG (Waldkirch, Germany)

Overfill containment system 130 may include an alarm system 194 electrically coupled to receive electrical signals output from the measuring system, e.g., output from flow sensor 142 and/or liquid sensor 192 in response to flow sensor 142 sensing a continuous liquid flow and/or in response to liquid sensor 192 sensing the presence of liquid in overflow tank 132. Alarm system 194 might include a light 195 that lights, e.g., flashes, in response to alarm system 194 receiving electrical signals from flow sensor 142 and/or liquid sensor 192. Alarm system 194 might include a an audible alarm 196, such as a siren or a beeper configured to output a beeping sound, that is activated in response to alarm system 194 receiving electrical signals from flow sensor 142 and/or liquid sensor 192. Alarm system 194 might include a processor 198 (e.g., a computer processor) that is configured to cause a display 199 to output a message (e.g., a computerized message) indicative of an overflow in response to alarm system 194 receiving electrical signals from flow sensor 142 and/or liquid sensor 192.

For some embodiments, light 195 might include a portion responsive to the electrical signal from flow sensor 142 and another portion responsive to the electrical signal from liquid sensor 192, and audible alarm 196 might include a portion responsive to the electrical signal from flow sensor 142 and another portion responsive to the electrical signal from liquid sensor 192. Display 199 might be configured to indicate whether flow sensor 142 or liquid sensor 192 is sensing liquid.

Following is an explanation of the operation of tanker 100 without the overfill containment system 130. For example, flow line 210, indicated by a dashed line, would fluidly couple vapor recovery flow line 122 to vapor recovery flow line 180, and thus to valves 172 and to valve 182, so that compartments 105 are selectively fluidly coupled to outlet ports 170 by valves 172 and outlet port 184 by valve 182. In addition, compartments 105 (e.g., inlet/outlets 106 of compartments 105) would be selectively fluidly coupled to inlet/outlet ports 107 and pump 120 by valves 108, 110, and 112 and to inlet/outlet ports 116 by pump 120 and valves 117 (see FIGS. 1 and 8).

Liquid may then be added to a selected compartment 105 by activating (opening) a respective valve 110 and a respective valve 124, opening valve 112, opening a valve 108 for an inlet/outlet port 107 or a valve 117 for an inlet/outlet port 116, and opening valve 118 (see FIGS. 1 and 8). Valve 182 for outlet port 184 and/or valves 172 for outlet ports 170 are also opened (see FIGS. 1 and 8).

Liquid is then added to the selected compartment 105 from bulk storage tank 114 either through an inlet/outlet port 107, using a pump that is part of the bulk storage system that includes bulk storage tank 114, or through an inlet/outlet port 116, using pump 120. The liquid flows through open valve 112 and activated valve 110 and into the selected compartment 105 through the inlet/outlet 106 at the bottom of that compartment 105. As the liquid fills the selected compartment 105, air and vapor from the liquid (e.g., hereinafter referred to as gasses) above the liquid in the selected compartment 105 flow from the selected compartment 105 through the vapor recovery flow line 122, through the activated valve 124, through flow line 210, through vapor recovery flow line 180, and to the surroundings (e.g., atmosphere) through outlet ports 170 and/or outlet port 184. The liquid flow is stopped when it is deemed that the selected compartment 105 is full.

Reversing the direction of the pump that is part of the bulk storage system unloads a selected compartment 105 by causing liquid to flow from selected compartment 105 (e.g., through inlet/outlet 106) through activated valve 110, open valve 112, and open valve 108, through inlet/outlet port 107, through open valve 118, and into bulk storage tank 114. Reversing the direction of pump 120 unloads a selected compartment 105 by causing liquid to flow from selected compartment 105 through activated valve 110, open valve 112, and open valve 117, through inlet/outlet port 116, through open valve 118, and into bulk storage tank 114.

In the event of an overflow of liquid during filling of the selected compartment 105, the liquid will flow from the selected compartment 105 through the vapor recovery flow line 122, through the activated valve 124, through flow line 210, through vapor recovery flow line 180, and to the surroundings (e.g., onto the ground) through outlet ports 170 and/or outlet port 184. Bucket 186 might collect some of the overflowing liquid flowing through outlet port 184, but some of the liquid can splash out through the open top, e.g., to the ground. The embodiments disclosed herein act (e.g., overfill containment system 130 acts) to prevent the overflowing liquid from reaching the atmosphere and thus the ground by containing the overflowing liquid, e.g., in overflow tank 132.

Following is an explanation of the operation of overfill containment system 130 during the operation of tanker 100, e.g., while filing a selected compartment 105. Note that flow line 210 is not present when overfill containment system 130 is installed. Note further that for a single-compartment tank, the selected compartment corresponds to the entire tank.

To fill the selected compartment 105, a respective valve 110 and a respective valve 124 are activated. A valve 108 for inlet/outlet port 107 or a valve 117 for inlet/outlet port 116 is opened, and valve 118 is opened (see FIGS. 1 and 8). Valves 140 and 174 are opened. Valve 182 for outlet port 184 and/or valves 172 for outlet ports 170 are also opened (see FIGS. 1 and 8). Valves 154, 158, and 164 remain closed. Liquid is then added to the selected compartment 105 from bulk storage tank 114 either through an inlet/outlet port 107, using the pump that is part of the bulk storage system that includes bulk storage tank 114, or through an inlet/outlet port 116, using pump 120.

The liquid is directed through flow line 113, through open valve 112 and activated valve 110, and into the selected compartment 105 through the inlet/outlet 106 of that compartment 105. As the liquid fills the selected compartment 105, the gasses above the liquid in the selected compartment 105 are directed from the selected compartment 105 through the vapor recovery flow line 122 and through the activated valve 124. The gasses from vapor recovery flow line 122 are directed through flow line 141, through flow sensor 142, through filter 144, through open valve 140, through sight glass 146, and into overflow tank 132 through inlet 134. The gasses are then directed from overflow tank 132 through outlet 136. The gasses are directed from outlet 136 through flow line 178 and through open valve 174 to vapor recovery flow line 180 of the vapor-release system of tanker 100. The gases are then directed to atmosphere through open valves 172 and outlet ports 170 and/or through open valve 182 and outlet port 184. The liquid flow is stopped when it is deemed that the selected compartment 105 is full.

Reversing the direction of the pump that is part of the bulk storage system unloads a selected compartment 105 by causing liquid to flow from selected compartment 105 through the inlet/outlet 106 of the selected compartment 105. The liquid is directed from inlet/outlet 106 through flow line 113, through activated valve 110, through open valve 112, through open valve 108, through inlet/outlet port 107, through open valve 118, and into bulk storage tank 114.

Reversing the direction of pump 120 unloads a selected compartment 105 by causing liquid to flow from selected compartment 105 through the inlet/outlet 106 of the selected compartment 105. The liquid is directed from inlet/outlet 106 through flow line 113, through activated valve 110, and through open valve 112 to pump 120. The flow is directed through pump 120, through flow line 121, through open valve 117, through inlet/outlet port 116, through open valve 118, and into bulk storage tank 114.

In the event of an overflow of liquid, during the filling of the selected compartment 105, the liquid overflow is directed from the selected compartment 105 through the vapor recovery flow line 122 and through the activated valve 124 to flow line 141. The liquid from the vapor recovery flow line 122 is directed through flow line 141, through flow sensor 142, through filter 144, through open valve 140, through sight glass 146, and into overflow tank 132 through inlet 134.

Flow sensor 142 sends an electrical signal to alarm system 194 in response to flow sensor 142 sensing a continuous flow of the liquid overflow. In response to receiving the electrical signal from flow sensor 142, alarm system 194 may then output a visual alarm, e.g., by causing light 195 to light or flash, an audible alarm, e.g., by causing audible alarm 196 to emit a sound, and/or display 199 to display a message indicative of an overflow.

Liquid sensor 192 sends an electrical signal to alarm system 194 in response to liquid sensor 192 sensing the presence of the liquid overflow in overflow tank 132. In response to receiving the electrical signal from liquid sensor 192, alarm system 194 may then output a visual alarm, e.g., by causing light 195 to light or flash, an audible alarm, e.g., by causing audible alarm 196 to emit a sound, and/or display 199 to display a message indicative of an overflow.

Liquid-level gauge 188 outputs the level (e.g., the instantaneous level) of the liquid overflow in overflow tank 132 in response to the liquid overflow accumulating in overflow tank 132. Sight glass 146 provides a visual indication of the flowing liquid overflow as it enters overflow tank 132. Alarm system 194, liquid-level gauge 188, and/or sight glass 146 alert the operator of a liquid overflow condition. Collecting the liquid overflow in overflow tank 132 gives the operator time to stop the liquid flow, in response to the alerts from alarm system 194, liquid-level gauge 188, and/or sight glass 146, before the liquid overflow can spill into the surroundings.

After the liquid flow is stopped and the liquid overflow is contained in overflow tank 132, the liquid overflow can be returned to bulk storage tank 114 or to tank 102, e.g., to a compartment 105 that has room to hold the liquid overflow. To return liquid from overflow tank 132 to bulk storage tank 114, valves 124, valves 110, and valve 158 are closed, and valves 112, 118, 140, 154, 164, and 174 are opened. Valve 182 for outlet port 184 and/or valves 172 for outlet ports 170 are also opened (see FIGS. 1 and 8). A valve 108 for an inlet/outlet port 107 is opened when it is desired to return the liquid to bulk storage tank 114 through that inlet/outlet port 107, using the pump that is part of the bulk storage system that includes bulk storage tank 114. Alternatively, a valve 117 for an inlet/outlet port 116 is opened when it is desired to return the liquid to bulk storage tank 114 through that inlet/outlet port 116, using pump 120.

Activating the pump that is part of the bulk storage system returns the liquid from overflow tank 132 to bulk storage tank 114 by causing liquid to flow from overflow tank 132 through outlet 138. The liquid is directed from outlet 138 through flow line 160, through check valve 162, through open valve 154, through flow line 166, and through open valve 164 to flow line 113. The liquid is directed through flow line 113, through open valve 112, through open valve 108, through inlet/outlet port 107, through open valve 118, and into bulk storage tank 114.

Activating pump 120 returns the liquid from overflow tank 132 to bulk storage tank 114 by causing liquid to flow from overflow tank 132 through outlet 138. The liquid is directed from outlet 138 through flow line 160, through check valve 162, through open valve 154, through flow line 166, and through open valve 164 to flow line 113. The liquid is directed through flow line 113, through open valve 112, through pump 120, through flow line 121, through open valve 117, through inlet/outlet port 116, through open valve 118, and into bulk storage tank 114.

To return liquid from overflow tank 132 to a selected compartment 105 (e.g., compartment 105₁), valve 118, valves 108 for inlet/outlet ports 107, valves 117 for inlet/outlet ports 116, and valve 164 are closed, and valves 112, 154, 158, and 174 are opened. Valve 182 for outlet port 184 and/or valves 172 for outlet ports 170 are also opened (see FIGS. 1 and 8). The air-actuated valves 110 and 124 corresponding to (e.g., fluidly coupled to) the selected compartment 105₁ are opened, whereas the air-actuated valves 110 and 124 corresponding to (e.g., fluidly coupled to) an unselected compartment (e.g., compartment 105₂) are closed.

Activating pump 120 returns the liquid from overflow tank 132 to selected compartment 105₁ by causing the liquid to flow from overflow tank 132 through outlet 138. The liquid is directed from outlet 138 through flow line 160, through check valve 162, through open valve 154, and through open valve 158 to flow line 121. The liquid is directed through flow line 121 and pump 120 to flow line 113. The liquid is directed through flow line 113, through open valve 112, through open valve 110, and through the inlet/outlet 106 of selected compartment 105₁ into selected compartment 105₁. Note that when returning the liquid from overflow tank 132 to a selected compartment 105, the operation of pump 120 reversed relative to its operation when returning the liquid from overflow tank 132 to bulk storage tank 114.

### CONCLUSION

Although specific embodiments have been illustrated and described herein, it will be appreciated by those of ordinary skill in the art that any arrangement that is calculated to achieve the same purpose may be substituted for the specific embodiments shown. Many adaptations of the embodiments will be apparent to those of ordinary skill in the art. Accordingly, this application is intended to cover any adaptations or variations of the embodiments.

What is claimed is:

1. An overfill containment system for a tanker, comprising:
an overflow tank comprising an inlet selectively fluidly coupleable to a vapor-release system of the tanker and an outlet selectively fluidly coupleable to an input/output port of the tanker and to an inlet/outlet of a tank of the tanker;
wherein the input/output port of the tanker and the inlet/outlet of the tank are for liquid.

2. The overfill containment system of claim 1, wherein the outlet of the overflow tank allows liquid overflow from the tank that is collected in the overflow tank to flow out of the overflow tank to the input/output port of the tanker and to the inlet/outlet of the tank of the tanker.

3. The overfill containment system of claim 1, wherein the overflow tank is mounted on the tanker so that the overflow tank travels with the tanker as the tanker travels over land.

4. The overfill containment system of claim 1, wherein the inlet of the overflow tank allows gasses and liquid overflow from the tank of the tanker to enter the overflow tank from the vapor-release system.

5. The overfill containment system of claim 1, wherein the outlet of the overflow tank is selectively fluidly coupleable to a pump of the tanker.

6. The overfill containment system of claim 1, further comprising:
a flow sensor selectively fluidly coupled to the inlet of the overflow tank, wherein the flow sensor is configured to output an electrical signal in response to the flow sensor sensing a flow of liquid; and
an alarm system configured output an indication of an overflow condition in response to receiving the electrical signal output by the flow sensor.

7. The overfill containment system of claim 1, further comprising:
a liquid sensor within the overflow tank, wherein the liquid sensor is configured to output an electrical signal in response to the liquid sensor sensing liquid in the overflow tank; and
an alarm system configured output an indication of an overflow condition in response to receiving the electrical signal output by the liquid sensor.

8. The overfill containment system of claim 1, further comprising a sight glass fluidly coupled to the inlet of the overflow tank.

9. The overfill containment system of claim 1, further comprising at least one of a filter selectively fluidly coupled to the inlet of the overflow tank, a pressure gauge fluidly coupled to an interior of the overflow tank, and liquid-level gauge fluidly coupled to the interior of overflow tank.

10. The overfill containment system of claim 1, wherein the overflow tank comprises another outlet selectively fluidly coupleable to an outlet port of the vapor-release system.

11. The overfill containment system of claim 1, wherein the outlet of the overflow tank passes through a bottom of the overflow tank.

12. The overfill containment system of claim 1, wherein the outlet of the overflow tank is fluidly coupled to a check valve that prevents liquid from entering the overflow tank through the outlet of the overflow tank.

13. An overfill containment system for a tanker, comprising:
an overflow tank;
wherein the overfill containment system is configured to direct a liquid overflow to the overflow tank from a flow line of a vapor-release system of the tanker that opens into a tank of the tanker;
wherein the overfill containment system is configured to direct the liquid overflow from the overflow tank to a liquid-handling system the tanker; and
wherein the liquid-handling system is selectively fluidly coupled to an inlet/outlet port of the tanker and to an inlet/outlet of the tank of the tanker.

14. The overflow system of claim 13, wherein the liquid-handling system comprises a pump that is selectively fluidly coupled to the inlet/outlet port of the tanker and to the inlet/outlet of the tank of the tanker.

15. The overflow system of claim 13, further comprising a measuring system configured to determine whether the liquid overflow is being directed to the overflow tank from the flow line and/or configured to determine whether the liquid overflow is in the overflow tank, wherein the measuring system is configured to output an electrical signal in response to the measuring system determining that the liquid overflow is being directed to the overflow tank from the flow line and/or that the liquid overflow is in the overflow tank.

16. The overflow system of claim 15, further comprising an alarm system configured indicate an overflow in response to receiving the electrical signal output from the measuring system.

17. The overflow system of claim 13, wherein the overfill containment system is configured to direct gasses to the overflow tank from the flow line as the tank of the tanker is being filled with liquid.

18. The overflow system of claim 17, wherein the overfill containment system is configured to direct the gasses from the overflow tank to another flow line of the vapor-release system as the first tank is being filled liquid, wherein the other flow line is selectively fluidly coupled to an output port of the vapor-release system.

19. A tanker, comprising:
a pump selectively fluidly coupled to an inlet/outlet port of the tanker;
a first tank comprising an inlet/outlet for liquids selectively fluidly coupled to the pump; and
a second tank configured as an overflow tank and comprising an outlet selectively fluidly coupled to the pump and an inlet selectively fluidly coupled to a vapor-release system that extends into the first tank.

20. The tanker of claim 19, wherein first tank comprises a plurality of compartments and wherein the inlet/outlet for liquids being selectively fluidly coupled to the pump comprises an inlet/outlet for liquids of each of the plurality of compartments being selectively fluidly coupled to the pump, and wherein the vapor-release system that extends into the first tank comprises a vapor-release system that extends into each of the plurality of compartments.

21. The tanker of claim 19, wherein the tanker is a land-based tanker.

22. The tanker of claim 19, wherein liquid overflow collected in the second tank is directed through the outlet of second tank to the inlet/outlet of the first tank in response to activating the pump.

23. The tanker of claim 19, wherein liquid overflow collected in the second tank is directed through the outlet of second tank to the inlet/outlet port of the tanker in response to activating the pump.
